(19) United States
(12) Patent Application Publication
(10) Pub. No.: US 2025/0159034 A1
(43) Pub. Date: May 15, 2025

(54) METHOD AND APPARATUS FOR IMPROVING SELECTIVE FORWARDING UNITS BANDWIDTH ESTIMATION OF VARIABLE BITRATE-ENCODED STREAMS' SUBSCRIBERS THROUGH PADDING NETWORK BOOSTING

(71) Applicant: Vonage Business Inc., Holmdel, NJ (US)

(72) Inventors: Sara ALVAREZ-CORTES, Barcelona (ES); Andres BERSIER, Barcelona (ES); Oscar DIVORRA-ESCODA, Barcelona (ES); Natale PATRICIELLO, Barcelona (ES); Vamis XHAGJIKA, Barcelona (ES)

(21) Appl. No.: 18/839,411

(22) PCT Filed: Feb. 21, 2023
(86) PCT No.: PCT/US2023/013466

§ 371 Date: Aug. 16, 2024

Related U.S. Application Data
(60) Provisional application No. 63/311,699, filed on Feb. 18, 2022.

(51) Int. Cl. H04L 65/80; H04L 65/65; H04L 65/752

(52) U.S. Cl. CPC H04L 65/80; H04L 65/65; H04L 65/752

(57) ABSTRACT

A method and apparatus for determining a padding budget for improving bandwidth estimation of data streams encoded with variable bitrate include receiving a data stream having a variable bitrate, comparing a bandwidth estimation determined for a communication path between a data stream forwarding unit and an intended receiver of the data stream to a padding threshold. If the bandwidth estimation is less than the padding threshold, the padding budget is determined by subtracting a bitrate of the data stream from the bandwidth estimation. If the bandwidth estimation is not less than the padding threshold, the bitrate is compared to a padding baseline. If the bitrate is less than the padding baseline, the padding budget is determined by subtracting the bitrate from the padding baseline, and if the bitrate is not less than the padding baseline, no padding needs to be added to the data stream to be communicated to the intended receiver.

### BACKGROUND

### Field

Embodiments of the present principles generally relate to bandwidth estimation enhancement between a Selective Forwarding Unit (SFU) and associated end-points and more specifically to a method and apparatus for improving the estimation and maintenance of bandwidth between a SFU and associated end-points by more efficiently probing the network when sharing real-time media encoded with variable bitrates,

### Description of the Related Art

Current real-time communication sessions use a Selective Forwarding Unit (SFU), which receives and sends audio and video streams between peers (direct peer-to-peer), i.e., from and to each session participant via separated forwarding channels. SFUs are especially used due to their efficiency and flexibility when compared to mixing servers like MCUs. Currently, WebRTC/RTCWeb engines offer the possibility of enabling all modern web browsers and mobile applications to execute application programming interfaces (APIs) for providing real-time communications, without the requirement of installing external plugins in browsers, and perfectly interoperate with downloaded native applications.

Generally, for each participant sending media in a real-time conference running on top of WebRTC, a RTC peer connection is established between the sender (publisher) and the SFU, which will later forward the media to the receivers (subscribers). The SFU acts thus, as a smart relay that not only delivers the media packets to their corresponding destinations, but also applies some packets filtering and network congestion control algorithms to avoid, to the extent possible, packets latency and losses that could dramatically affect the user Quality of Experience (QoE). An SFU, however, cannot modify the data within the stream received from the publisher and, since overloading the network by sending stream bitrates that overpass the available bandwidth would give rise to adverse communication effects, e.g., packet loss and retransmissions, SFUs need to compute the peer-to-peer available bandwidths and send the media with a well-adapted bitrate.

Current state of the art solutions for attempting to send media using a well-adapted bitrate in single quality transmission topologies (e.g., non-simulcast) include implementing a maximum allowed bitrate sent by the publisher, which will be the result of some arithmetic rule applied to all the bandwidth estimates between the SFU and each subscriber. However, such solutions do not scale well for applications having many participants since it generally only takes one subscriber with a poor internet connection to penalize the experience for all the subscribers. To avoid degrading the quality of the experience of the rest of the subscribers, the publisher can send multiple quality data, e.g. with different resolutions (simulcast), and/or temporal scalability to the SFU, which then forwards the stream with the highest bitrate possible, but below the available bandwidth to each subscriber.

Conventionally, the term “rate-control” is used to describe the module, or combination of elements, that is in charge of discovering the usable maximum data rate (bandwidth estimation) from a publisher and towards any subscriber. Rate-control must take into account multiple factors, such as the variability of the connection or the congestion events caused by concurrent flows. Rate-control needs to also take into account whether it is end-to-end among publisher and subscribers (through the SFU), or by parts between publisher and SFU and between SFU and subscribers. A typical process begins with a minimum rate, and then increases the rate based on a parameter combination until this combination shows signs of full usage of the communication channel. Rate-control typically operates on a loop, trying to detect, and even more trying to predict in advance, any over-use and/or under-use of communications channels so as to try to constantly and carefully adjust how much data is communicated.

A common state of the art solution for sensing the available bandwidth of the receiver's channel, regardless of the actual data rate transmitted, includes adding padding to the media stream packets to increase its effective bitrate in order to better sense the effect of the added padding to the data over the communications path. It is possible that even adding all the padding possible to each media data packet and making the media stream packets size the maximum possible that avoids packet fragmentation, the effective bitrate of the media stream can still be below the real bandwidth of the network. In that case, pure padding packets, which are not generated by the publisher, can be sent from the SFU to the subscriber, allowing the receiver to estimate the real bandwidth of the channel. Otherwise, it is not possible to keep increasing the effective bitrate of the stream, even though some packets contain some amount of padding. These pure padding packets, generated by the SFU, must be sent at the end of a frame to keep compatibility with some receivers, between the media stream marker and non-marker packets. When using receiver-side strategies, the estimated bandwidth is a function of, among other stats, the received rate. Therefore, increasing it with probing may be notably useful under certain conditions, for example, to switch nimbly between qualities when the SFU is dealing with a simulcast and/or scalable stream. Such methods, however, do not work under all circumstances.

For example, often, camera streams or screen-sharing video flows include steady motion and/or constant variations over time and require a high enough bitrate to push the bandwidth estimation up, reliably, without the need to rely on any extra strategy to pump up the packet-sending ratio. However, when a sender that is operating on variable bitrate (i.e., when the bitrate required to encode the original content according to a target quality varies, being it normally low for static or high for dynamic contents, and giving rise to impaired bandwidth network estimations), for instance in cases often related with screen sharing in which encoding may be tuned to favor efficiency with static or quasi-static content, the bitrate, and thus packets, used to encode it may usually become very low at times due to the lack of data variability. In such scenarios, senders send stream bitrates far below the subscribers' available bandwidth and therefore, SFUs forward not enough bitrate to efficiently predict the network capacity. Consequently, subscribers receive poor quality streams, normally manifesting as blurred, frozen or slow transitioning screen's stream data, especially when transitioning from static to motion content where the bandwidth estimation is deficient. This is because when the publisher's video becomes dynamic, there will not be enough bandwidth according to current estimation methods to send it with an acceptable quality until the receiver can estimate the real value of the available bandwidth, after a ramp-up time. These issues may affect both cases, single quality and/or multi-quality streams, however the ramp-up time needed to estimate the real value of the current available bandwidth is much higher if the stream content type changes from static to dynamic, than for the initial ramp-up when a stream is created and has dynamic content from the very beginning.

In addition, in single quality communication systems it is common to force the SFUs to send only bitrates aligned to the worst of the subscribers' estimated bandwidth, significantly penalizing the bitrate transmission to the different end-points every time any subscriber bandwidth drops, and thus resulting in the emergence of harsh fall-downs in screen media quality that are hard to recover. Moreover, in such systems each time a new participant joins the group call, screen quality may be reduced to accommodate the conservative initial bandwidth estimation the SFU has configured to account for potential network constraints of the new joiner. Note that once a new participant subscribes to the SFU, the end-to-end rate-control and bandwidth estimation has to conduct the network capacity ramp-up again. If the publisher is sharing static content and/or in a very low bitrate phase (i.e. when the encoding allows for variable bitrate transmission), these ramp-ups might not even be achieved. And, as mentioned previously, these consecutive ramp-ups take into account previous stats, where these down-falls tend to negatively affect the bandwidth estimation computation and extend over time if no solution to avoid them is provided.

Another possible scenario is having a high bandwidth estimation because of a past dynamic stream content, but currently encoding a low bitrate stream. In this case, a small disruption in the network, such as packet loss, delay or jitter could drop the receiver's estimated bandwidth to a value below the received bitrate. If the received stream's bitrate were to be higher, the drop would be less pronounced. These issues may again affect both single quality and multi-quality streams.

As such, it can be summarized that state of the art solutions for estimating subscriber-side bandwidth for data streams suffer from at least poor bandwidth prediction ramp-ups when sharing low-bitrate contents, high responsiveness in the bandwidth estimation to short network disturbances in the bandwidth estimation when sharing low-bitrate content and deficient ramp-up bandwidth estimation speeds for the SFU subscribing connections if the transmitted content is variable bitrate encoded, giving rise to impaired Quality of Experience.

Therefore, there is a need in the art for a smart padding injection method and apparatus for improved subscribers-side bandwidth estimation for data streams encoded with variable bitrate.

### SUMMARY

Methods and apparatuses for improving SFU bandwidth estimation of data streams encoded with variable bitrate are provided herein.

In some embodiments a method for determining a padding budget for improving bandwidth estimation of data streams encoded with variable bitrate includes receiving a data stream having a variable bitrate, comparing a bandwidth estimation determined for a communication path between a data stream forwarding unit and a respective, intended receiver of the data stream to a padding threshold, if the bandwidth estimation is less than the padding threshold, determining the padding budget by subtracting a bitrate of the received data stream from the bandwidth estimation, if the bandwidth estimation is not less than the padding threshold, comparing the bitrate of the received data stream to a padding baseline, if the bitrate of the received data stream is less than the padding baseline, determining the padding budget by subtracting the bitrate of the received data stream from the padding baseline, and if the bitrate of the received data stream is not less than the padding baseline, determining that the padding budget is zero and that no padding needs to be added to the data stream to be communicated to the intended receiver.

In some embodiments, the method can further include adding padding to the data stream in accordance with the determined padding budget and communicating the data stream including the added padding to the respective, intended receiver.

In some embodiments in which the received data stream includes a multi-quality data stream, the method can further include comparing a bandwidth estimation determined for a communication path between the data stream forwarding unit and an intended receiver of the data stream having a highest quality of the multi-quality data stream, and if the bandwidth estimation is less than the padding threshold, determining the padding budget by subtracting a bitrate of the received, highest quality data stream from the bandwidth estimation.

In some embodiments of the present principles, the method can further include receiving Real-Time Transport Protocol (RTP) feedback data from the intended subscriber, an determining the bandwidth estimation using the RTP feedback data.

In some embodiments of the present principles, an apparatus for determining a padding budget for improving bandwidth estimation of data streams encoded with variable bitrate includes a receiver bandwidth estimator configure to receive a data stream having a variable bitrate and determine a bandwidth estimation of a communication path between the apparatus and a respective, intended receiver of the data stream. The apparatus can further include a padding adder configure to compare a bandwidth estimation determined for a communication path between a data stream forwarding unit and an intended receiver of the data stream to a padding threshold and if the bandwidth estimation is less than the padding threshold, determine the padding budget by subtracting a bitrate of the received data stream from the bandwidth estimation, and if the bandwidth estimation is not less than the padding threshold, compare the bitrate of the received data stream to a padding baseline, and if the bitrate of the received data stream is less than the padding baseline, determine the padding budget by subtracting the bitrate of the received data stream from the padding baseline, and if the bitrate of the received data stream is not less than the padding baseline, determine that the padding budget is zero and that no padding needs to be added to the data stream to be communicated to the intended receiver.

In some embodiments, in the apparatus, the padding adder is further configured to add padding to the data stream in accordance with the determined padding budget. Such embodiments can include a sending engine configured to communicate the data stream including the added padding to the respective, intended receiver.

In some embodiments in which the received data stream comprises a multi-quality data stream, the padding adder is further configured compare a bandwidth estimation determined for a communication path between the data stream forwarding unit and an intended receiver of the data stream having a highest quality of the multi-quality data stream, and if the bandwidth estimation is less than the padding threshold, determine the padding budget by subtracting a bitrate of the received, highest quality data stream from the bandwidth estimation.

In some embodiment of an apparatus of the present principles, the receiver bandwidth estimator is further configured to receive Real-Time Transport Protocol (RTP) feedback data from the respective, intended subscriber, and determine the bandwidth estimation using the RTP feedback data.

In some embodiments of the present principles, an apparatus for determining a padding budget for improving bandwidth estimation of data streams encoded with variable bitrate includes a processor and a memory coupled to the processor. In such embodiments, the memory has stored therein at least one of programs or instructions executable by the processor to configure the apparatus to receive a data stream having a variable bitrate, compare a bandwidth estimation determined for a communication path between a data stream forwarding unit and a respective, intended receiver of the data stream to a padding threshold, if the bandwidth estimation is less than the padding threshold, determine the padding budget by subtracting a bitrate of the received data stream from the bandwidth estimation, if the bandwidth estimation is not less than the padding threshold, compare the bitrate of the received data stream to a padding baseline, if the bitrate of the received data stream is less than the padding baseline, determine the padding budget by subtracting the bitrate of the received data stream from the padding baseline, and if the bitrate of the received data stream is not less than the padding baseline, determine that the padding budget is zero and that no padding needs to be added to the data stream to be communicated to the intended receiver.

In some embodiments, the apparatus is further configured to add padding to the data stream in accordance with the determined padding budget and communicate the data stream including the added padding to the respective, intended receiver.

In some embodiments, in which the received data stream comprises a multi-quality data stream, the apparatus is further configured to compare a bandwidth estimation determined for a communication path between the data stream forwarding unit and an intended receiver of the data stream having a highest quality of the multi-quality data stream, and if the bandwidth estimation is less than the padding threshold, determine the padding budget by subtracting a bitrate of the received, highest quality data stream from the bandwidth estimation.

In some embodiments of an apparatus of the present principles, the apparatus is further configured to receive Real-Time Transport Protocol (RTP) feedback data from the respective, intended subscriber and determine the bandwidth estimation using the RTP feedback data.

Other and further embodiments of the present principles are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a flow diagram of a method for determining a padding boosting budget for a single quality media stream in accordance with an embodiment of the present principles.

FIG. 2 depicts a flow diagram of a method for determining a padding boosting budget for a multi-quality media stream in accordance with an embodiment of the present principles.

FIG. 3 depicts a high-level block diagram of a selective forwarding unit (SFU) in accordance with an embodiment of the present principles.

FIG. 4 depicts a graphical representation of an embodiment of a Padding Booster strategy of the present principles for increasing multi-quality (simulcast) video stream qualities that an SFU of the present principles, such as the SFU of FIG. 3, can forward to each end-point.

FIG. 5 depicts a graphical representation of an amount of bitrate an SFU of the present principles, such as the SFU of FIG. 3, sends to end-points.

FIG. 6 depicts a graphical representation of an embodiment of the evolution of an end-point bandwidth estimation of an SFU of the present principles, such as the SFU of FIG. 3, after receiving a burst of delayed packets in a row.

FIG. 7 depicts a computer system that can be used to implement an SFU of the present principles and the methods of FIG. 1 and FIG. 2 in accordance with various embodiments of the present principles.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for improving SFU bandwidth estimation of data streams encoded with variable bitrate. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to specific media/data streams, such teachings should not be considered limiting. Embodiments in accordance with the present principles can be applied to other similar data.

In the following description, the term selective forwarding unit (SFU) is used to describe and refer to an apparatus that selectively forwards media packets from a source (referred to as publisher or sender) to a receiver (referred to as subscriber or receiver) and performs as a media router.

In embodiments described herein, the term padding is used to describe and refer to bits or characters that fill up unused portions of a data structure, such as a field, packet or frame. In some embodiments, padding can be added at the end of a data structure. In some embodiments, padding can consist of 1 bits, blank characters, and/or null characters.

In the following description, the terms stream, data stream, media stream, and the like, are used interchangeably and are intended to refer to and describe data for which at least bitrates and padding budgets can be determined in accordance with the present principles.

In some embodiments, a smart strategy, referred to herein as Padding Boosting, improves the efficiency of the bandwidth estimation discovery between an SFU and each of its end-point subscribers. The Padding Boosting solution of the present principles determines an equilibrated combination between a stream and padding bitrate that the SFU should send to subscribers, to enhance the bandwidth prediction ramp-up speed and accuracy without overloading the network which enables at least 1) faster recoveries under stressed network conditions, such as temporary disturbances; 2) faster initial bandwidth estimation ramp-ups; 3) ensuring a minimum estimate for fluent data flow transmissions; and 4) better media quality subscribers perception, especially when transitioning from totally static to harsh dynamic media content.

In some embodiments of the present principles, a Padding Boosting method includes combining a series of arithmetic rules for determining an amount of padding that an SFU should inject into the network while forwarding data streams to the participants subscribed to, for example, a real-time conference session. In some embodiments, a purpose of sending padding is to speed up and enhance the accuracy of the subscribers' bandwidth estimations, especially when forwarding low bitrate encoded streams for which the end-points' bandwidth feedback reports are usually underestimated, and therefore deficient. That is, when variable bitrate media is used, particularly when sharing screen content for instance, and/or programmatically rendered content on a canvas for streaming, the amount of bitrate invested for encoding can vary depending on the amount of changing information on the stream. This can apply to one or both, single quality and/or multi-quality streams. Very variable bitrate streams, where bitrate sent can be very little at times (e.g. very still scenes and/or static content), can become a challenge for the effective bandwidth estimation of the network over which the stream is sent. While the estimation task can be easier on purely peer-to-peer transmissions, having a forwarding unit (e.g., SFU and/or Real-Time Transport Protocol (RTP) middlebox) for multiparty requires some additional solution in order to enable rate-control to operate effectively and ramp-up fast enough in either end-to-end single quality stream situations, or subscribers' quality selection in multi-quality streams situations.

More specifically, in cases in which a video stream's bitrate is low on a variable bitrate encoded data stream, e.g. when sharing static content, not much new information needs to be encoded with each incoming frame. When the receiver receives a stream with a bitrate that is much lower than the real available bandwidth, it will not be capable of correctly estimating the bitrate value, since it can only guarantee that the available bandwidth is at least a value higher, but close to the received stream's bitrate. When the content is static, it requires a low bitrate that is normally lower or equal than the estimated bandwidth and therefore, no quality problem will be faced. However, the estimate can be lower than the encoded bitrate if the content suddenly changes to motion. That is, if after some time, a publisher's video becomes dynamic, there will not be enough bandwidth according to the estimation to send the video with an acceptable quality until the receiver can estimate the real value of the available bandwidth, after a ramp-up time. This ramp-up time is not the same immediately after the stream is created as after some time (e.g., minutes).

Specifically, at the beginning or first run, there are no stats about the bandwidth capacity of a receiver and the SFU begins to discover the network available for selecting the data rate to forward to the end-points. At this point, the bandwidth estimation normally increases fast enough until a certain limit, unlike the case where a communication (e.g., a call) has been running for a while. That means that, in the middle of a call, some stats about the past bandwidth values have already been collected and the estimation raises in a more conservative manner. These estimated ramp-ups are therefore slower.

When sharing static content, both, the first estimation ramp-up when no network capacity has been computed yet and for every drop-fall the network prediction experiences, benefit from the Padding Boosting strategy of the present principles. In some embodiments of the present principles, a Padding Booster logic for single quality and multi-quality streams compares the estimated bandwidth (BWestimation) with a padding threshold value (padding_th). If the estimated bandwidth is lower (BWestimation<padding_th) then padding is added by the SFU to the stream until the bandwidth prediction reaches, at least, the padding threshold value (padding_th). Otherwise, the SFU injects enough padding until the sum of the stream bitrate (received_stream_br) plus the padding_budget is equal to a given baseline bitrate (padding_bs). In this second case, and if the stream bitrate (received_stream_br) is higher than the baseline value (received_stream_br>padding_bs), the SFU will not send any extra padding (padding_budget=0).

For multi-quality streaming, if the bitrate required to encode the highest media quality is above the current bandwidth estimation, the SFU will allocate a padding budget to try to scale up qualities, regardless of the values of the threshold and the baseline. By forwarding a minimum bitrate to the end-points during the whole session (padding_bs), faster estimation ramp-ups are attained under any network disruption that might produce any drop in the bandwidth estimation beneath the threshold bitrate.

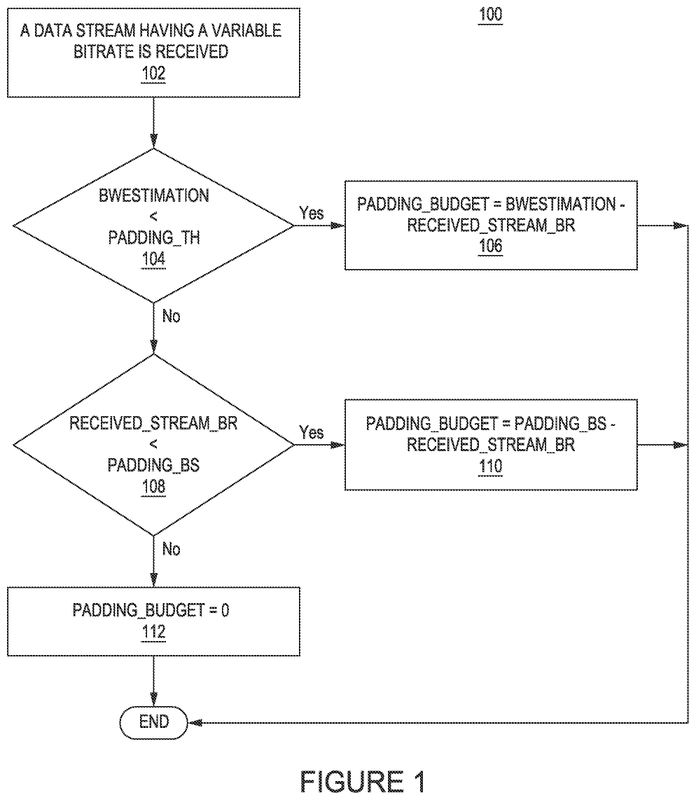

For example, FIG. 1 depicts a flow diagram of a method 100 for determining a padding boosting budget for a single quality media stream in accordance with an embodiment of the present principles. In the method 100 of FIG. 1, BWestimation represents a bandwidth estimation of a communication path/channel between an SFU and a given subscriber, received_stream_br represents the bitrate of the stream that the SFU is forwarding to the subscriber without any padding added by the SFU, padding_th represents the padding threshold value, padding_bs represents the padding baseline and padding_budget represents how much padding should be added by the SFU. That is, an SFU, using feedback from a subscriber, can estimate an amount of bandwidth available using algorithms, such as congestion detection algorithms. In addition, the SFU can determine a bitrate of the stream that the SFU is forwarding to the subscriber. The padding threshold value and the padding baseline are dependent on a configuration of a communication system in which embodiments of the present principles are being applied.

That is, in some embodiments in accordance with the present principles values for padding threshold and padding baseline are constants set and determined based on configuration of a communication system, rather than being determined dynamically. For example, in accordance with embodiments of the present principles, a padding threshold value can be set at a value necessary to transmit pure padding packets in bursts immediately following a marker packet. This value can be determined through experimental analysis as the optimal value to limit the size of these bursts to an acceptable level. In addition, a padding baseline value can be set to ensure that the bandwidth estimation ramp-up time would not be too slow by preventing the bandwidth from falling below a certain value when static content is being communicated in a data stream.

In some embodiments, a probing procedure can be performed to determine values for at least a padding threshold and padding baseline of the present principles. For example, a paced probing procedure of the present principles can included injecting (pacing) RTP Padding packets between marker and non-marker packets of a communication between an SFU of the present principles and a respective subscriber to artificially increase the data rate for a small and predefined amount of time to gather more information about the data channel. In some embodiments, the probing technique can include sending artificially-generated data at a much faster rate than a current bandwidth estimation to get information of the underlying network's state.

Referring back to FIG. 1, the method 100 of FIG. 1 can begin at 102 during which a data stream having a variable bitrate is received. The method 100 can proceed to 104.

At 104, the bandwidth estimation of a communication path/channel between the SFU and the subscriber, BWestimation, is compared to the padding threshold, padding_th. If the BWestimation is less than the padding_th, the method 100 proceeds to 106. If the BWestimation is not less than the padding_th, the method 100 skips to 108.

At 106, the padding budget, padding_budget, is determined by subtracting the received stream bitrate, received_stream_br, from the BWestimation. That is, in some embodiments the BWestimation can be converted to bitrate by, for example, dividing the bandwidth by 8, and then the received_stream_br can be subtracted from the bitrate determined from the BWestimation. The method 100 can then be exited.

At 108, it is determined if the received_stream_br is less than the padding baseline, padding_bs. If the received_stream_br is less than the padding baseline, padding_bs, the method proceeds to 110. If the received_stream_br is not less than the padding baseline, padding_bs, the method 100 skips to 112.

At 110, the padding_budget is determined by subtracting the received_stream_br from the padding_bs. The method 100 can then be exited.

At 112, the padding budget is determined to be zero (0) and that no padding needs to be added to the data stream to be communicated to the intended receiver. The method 100 can then be exited.

In accordance with the present principles and the embodiment of the method 100 of FIG. 1, the SFU can then provide padding to a media stream being communicated to a subscriber in accordance with the determined padding budget. More specifically, in some embodiments, padding is added to a received media/data stream to maintain a certain bitrate for a signal being communicated from an SFU of the present principles to an intended receiver of the media/data stream.

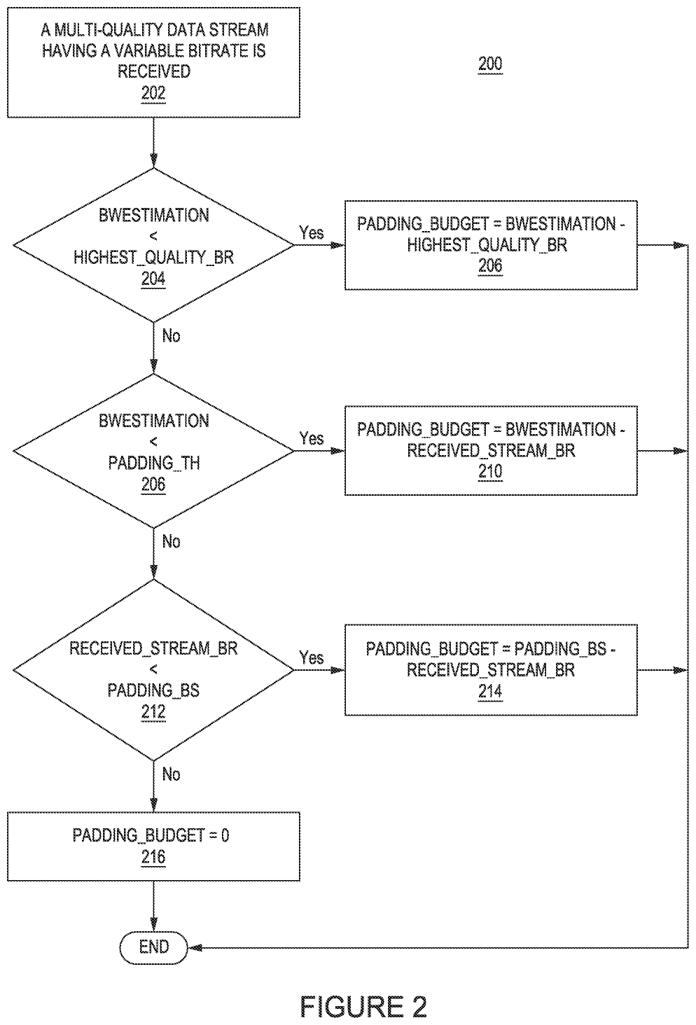

FIG. 2 depicts a flow diagram of a method 200 for determining a padding boosting budget for a multi-quality media stream in accordance with an embodiment of the present principles. In the embodiment of FIG. 2, BWestimation represents the bandwidth estimation for a communication path/channel between the SFU and a given subscriber, and highest__quality_br represents the bitrate of the highest quality stream received by the SFU from the publisher.

The method 200 of FIG. 2 can begin at 202 during which a multi-quality data stream having a variable bitrate is received. The method 200 can proceed to 204.

At 204, the BWestimation is compared to a bitrate of the highest quality stream, highest__quality_br, received by the SFU from a publisher. If the BWestimation is less than the highest__quality_br, the method 200 proceeds to 206. If the BWestimation is not less than the highest__quality_br, the method 200 skips to 208.

At 206, the padding_budget is determined by subtracting the highest__quality_br from the BWestimation. The method 200 can then be exited.

At 208, it is determined if the BWestimation is less than a padding_th. If the BWestimation is less than the padding_th, the method proceeds to 210. If the BWestimation is not less than the padding_th, the method 200 skips to 212.

At 210, the padding budget is determined by subtracting a received stream bitrate, received_stream_br, from the BWestimation. The method 200 can then be exited.

At 212, it is determined if a bitrate of the received stream, received_stream_br, is less than the padding baseline, padding_bs. If the received_stream_br is less than the padding baseline, padding_bs, the method 200 proceeds to 214. If the received_stream_br is not less than the padding baseline, padding_bs, the method 200 skips to 216.

At 214, the padding_budget is determined by subtracting the received_stream_br from the padding_bs. The method 200 can then be exited.

At 216, the padding budget is determined to be zero (0). The method 200 can then be exited.

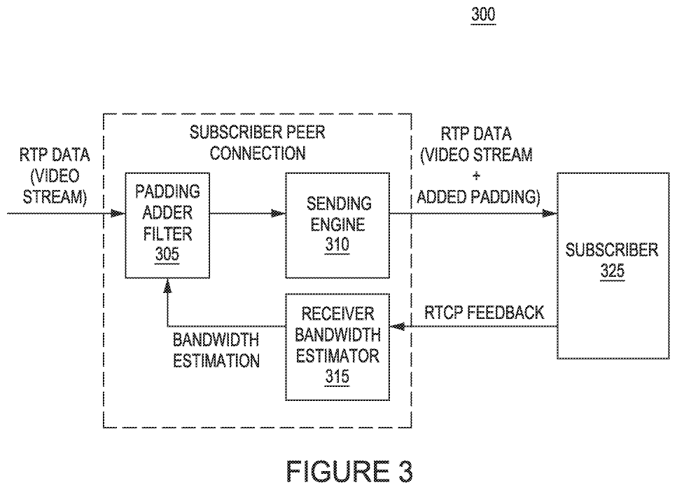

FIG. 3 depicts a high-level block diagram of a selective forwarding unit (SFU) 300 in accordance with an embodiment of the present principles. The SFU 300 of FIG. 3 illustratively comprises a padding adder module 305, a sending engine 310, and a receiver bandwidth estimator 315. In the embodiment of the SFU 300 of FIG. 3, the SFU 300 receives a video stream in the form of Real-Time Transport Protocol (RTP) data from, for example, a publisher (not shown). The padding adder module 305 of the SFU 300 can add padding to the received RTP data as described above in at least the method 100 of FIG. 1 and the method 200 of FIG. 2, in accordance with the present principles.

That is, in accordance with the present principles, the RTP media stream is assessed by the padding adder module 305 to compute an amount of padding to inject to the media stream according to a Padding Boosting strategy (method 100 and method 200) of the present principles to, for example, increase the total bitrate of a stream sent to each subscriber, particularly in the case of a low-bitrate video stream encoded by a publisher.

The video stream and computed padding can then be transmitted to a corresponding subscriber (e.g., end-point) using the sending engine 310. In some embodiments of the present principles, a Padding Adder module of the present principles can be added to each Subscriber Peer Connection established between the sending engine 310 and all subscribers.

In the embodiment of FIG. 3, the subscriber 325 feeds back RTP data to the SFU 300. The receiver bandwidth estimator 315 of the SFU 300 estimates the bandwidth of a respective subscriber using the RTP data from the subscriber using known techniques including but not limited to a Google Congestion Control (GCC) algorithm and a self-clocked rate adaptation technique which uses a hybrid loss-and-delay-based congestion control algorithm. In some embodiments and as depicted in FIG. 3, the bandwidth estimations determined by the receiver bandwidth estimator 315 using the RTCP data feedback from the subscriber 325 can be communicated to the padding adder module 305. In such embodiments, the padding adder module 305 can take into consideration the bandwidth estimation determined by the receiver bandwidth estimator 315 when computing an amount of padding to inject to the media stream.

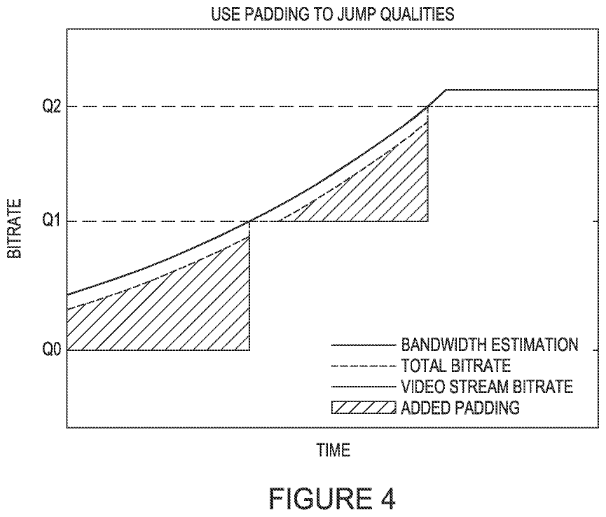

FIG. 4 depicts a graphical representation of an embodiment of a Padding Booster strategy of the present principles for increasing multi-quality (simulcast) video stream qualities that an SFU of the present principles, such as the SFU 300 of FIG. 3, can forward to each end-point, i.e., from the bitrate of the lowest quality (Q0) to the bit rate with highest quality (Q2). More specifically, FIG. 4 depicts a video stream bitrate sent from an SFU of the present principles to a subscribing endpoint when a video stream sent by the publishing endpoint includes a multi-quality (simulcast) data stream. In FIG. 4, the padding is added to increase the total bitrate sent to the subscribing endpoint enable it to increment the bandwidth estimation up until a point at which the SFU can decide to send a data stream of a next video quality to the subscribing endpoint. In the embodiment of FIG. 4, the 3 video qualities bitrates are represented by Q0, Q1 and Q2.

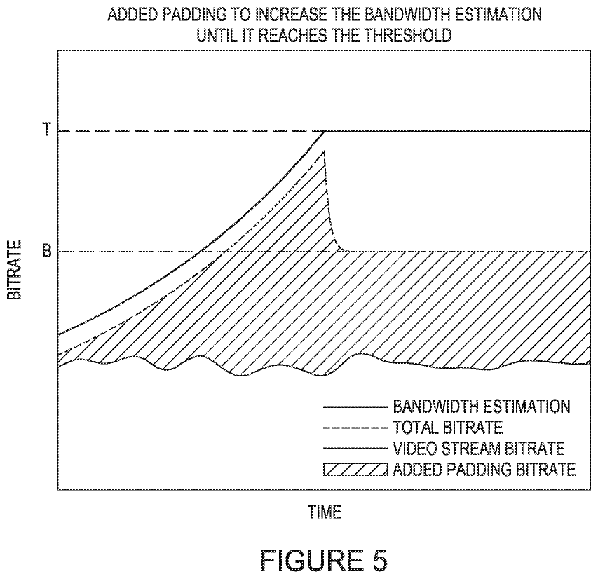

FIG. 5 depicts a graphical representation of an amount of bitrate an SFU of the present principles, such as the SFU 300 of FIG. 3, sends to end-points according to the bandwidth estimation of the present principles, received stream bitrate and padding budget information. Notice that in the embodiment of FIG. 5, a threshold value of 800 Kbps and a baseline value of 500 Kbps provide respectively high and low enough bitrates to ease faster estimation ramp-ups when the network faces any adverse effect, enough to reduce the bandwidth prediction below the threshold bitrate, and to count with a low enough estimation for affording a good user quality of experience.

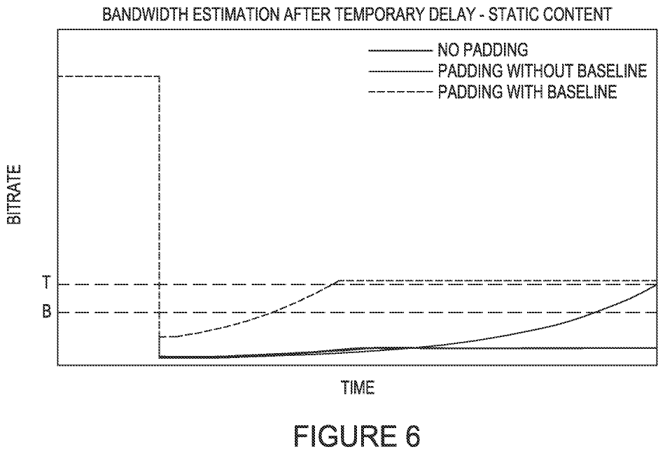

In accordance with the present principles, imposing a minimum bandwidth estimation (threshold bitrate) enables providing smooth and crisp shared content between peers and, consequently, afford high user quality of experience. On the other hand, with the baseline bitrate, the estimation can increase faster when the network suffers from enough disruption to decrease the estimation below the threshold bitrate. For example, FIG. 6 depicts a graphical representation of an embodiment of the evolution of an end-point bandwidth estimation of an SFU of the present principles, such as the SFU 300 of FIG. 3, after receiving a burst of delayed packets in a row. In FIG. 6, T represents the threshold bitrate and B represents the baseline bitrate. Typically in current systems, a bandwidth estimation is low or is unable to improve after a drop-fall when sending static content and no padding. However, as depicted in FIG. 6 and in accordance with the present principles, by ensuring a minimum bitrate (baseline value), the estimation is forced to be higher or reduced less after any network disturbance, enabling an SFU of the present principles, such as the SFU 300 of FIG. 3, to provide more resilience to network dropouts.

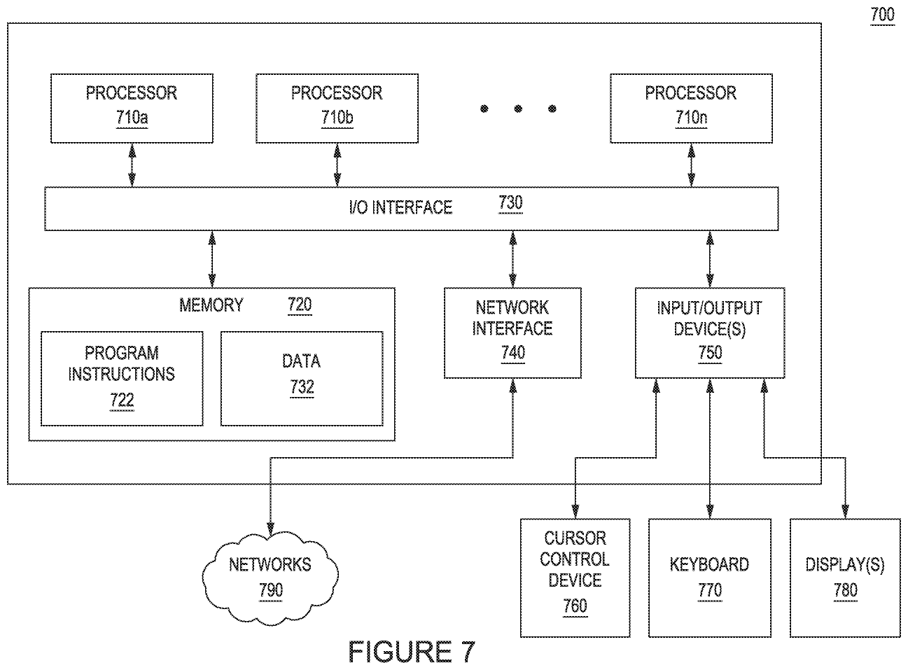

FIG. 7 depicts a computer system that can be used to implement an SFU of the present principles and the methods of FIG. 1 and FIG. 2 in accordance with various embodiments of the present principles. That is, various embodiments of a method, apparatus and system for determining a padding boosting budget, as described herein, may be executed on one or more computer systems, which may interact with various other devices. One such computer system is computer system 700 illustrated by FIG. 7, which may in various embodiments implement any of the elements or functionality illustrated in FIGS. 1-3. In various embodiments, computer system 700 may be configured to implement methods described above. The computer system 700 may be used to implement any other system, device, element, functionality or method of the above-described embodiments. In the illustrated embodiments, computer system 700 may be configured to implement methods 100 and 200, as processor-executable executable program instructions 722 (e.g., program instructions executable by processor(s) 710) in various embodiments.

In the illustrated embodiment, computer system 700 includes one or more processors 710 coupled to a system memory 720 via an input/output (I/O) interface 730. Computer system 700 further includes a network interface 740 coupled to I/O interface 730, and one or more input/output devices 750, such as cursor control device 760, keyboard 770, and display(s) 780. In various embodiments, any of components may be utilized by the system to receive user input described above. In various embodiments, a user interface (e.g., user interface 730) may be generated and displayed on display 780. In some cases, it is contemplated that embodiments may be implemented using a single instance of computer system 700, while in other embodiments multiple such systems, or multiple nodes making up computer system 700, may be configured to host different portions or instances of various embodiments. For example, in one embodiment some elements may be implemented via one or more nodes of computer system 700 that are distinct from those nodes implementing other elements. In another example, multiple nodes may implement computer system 700 in a distributed manner.

In different embodiments, computer system 700 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 700 may be a uniprocessor system including one processor 710, or a multiprocessor system including several processors 710 (e.g., two, four, eight, or another suitable number). Processors 710 may be any suitable processor capable of executing instructions. For example, in various embodiments processors 710 may be general-purpose or embedded processors implementing any of a variety of instruction set architectures (ISAs), such as the x96, PowerPC, SPARC, or MIPS ISAs, or any other suitable ISA. In multiprocessor systems, each of processors 710 may commonly, but not necessarily, implement the same ISA.

System memory 720 may be configured to store program instructions 722 and/or data 732 accessible by processor 710. In various embodiments, system memory 720 may be implemented using any suitable memory technology, such as static random access memory (SRAM), synchronous dynamic RAM (SDRAM), nonvolatile/flash-type memory, persistent storage (magnetic or solid state), or any other type of memory. In the illustrated embodiment, program instructions and data implementing any of the elements of the embodiments described above may be stored within system memory 720. In other embodiments, program instructions and/or data may be received, sent or stored upon different types of computer-accessible media or on similar media separate from system memory 720 or computer system 700.

In one embodiment, I/O interface 730 may be configured to coordinate I/O traffic between processor 710, system memory 720, and any peripheral devices in the system, including network interface 740 or other peripheral interfaces, such as input/output devices 750. In some embodiments, I/O interface 730 may perform any necessary protocol, timing or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components, such as a north bridge and a south bridge, for example. Also, in some embodiments some or all of the functionality of I/O interface 730, such as an interface to system memory 720, may be incorporated directly into processor 710.

Network interface 740 may be configured to allow data to be exchanged between computer system 700 and other devices attached to a network (e.g., network 790), such as one or more external systems or between nodes of computer system 700. In various embodiments, network 790 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 740 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 750 may, in some embodiments, include one or more display terminals, keyboards, keypads, touch pads, scanning devices, voice or optical recognition devices, or any other devices suitable for entering or accessing data by one or more computer systems 700. Multiple input/output devices 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 740.

Those skilled in the art will appreciate that computer system 700 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

While the foregoing is directed to embodiments of the present principles, other and further embodiments of the invention may be devised without departing from the basic scope thereof, and the scope thereof is determined by the claims that follow.

1. A method for determining a padding budget for improving bandwidth estimation of data streams encoded with variable bitrate, comprising:
receiving a data stream having a variable bitrate;
comparing a bandwidth estimation determined for a communication path between a data stream forwarding unit and a respective, intended receiver of the data stream to a padding threshold;
if the bandwidth estimation is less than the padding threshold, determining the padding budget by subtracting a bitrate of the received data stream from the bandwidth estimation;
if the bandwidth estimation is not less than the padding threshold, comparing the bitrate of the received data stream to a padding baseline;
if the bitrate of the received data stream is less than the padding baseline, determining the padding budget by subtracting the bitrate of the received data stream from the padding baseline; and
if the bitrate of the received data stream is not less than the padding baseline, determining that the padding budget is zero and that no padding needs to be added to the data stream to be communicated to the intended receiver.

2. The method of claim 1, further comprising:
adding padding to the data stream in accordance with the determined padding budget.

3. The method of claim 2, further comprising:
communicating the data stream including the added padding to the respective, intended receiver.

4. The method of claim 1, wherein the received data stream comprises a multi-quality data stream and the method of claim 1 further comprises:
comparing a bandwidth estimation determined for a communication path between the data stream forwarding unit and an intended receiver of the data stream having a highest quality of the multi-quality data stream; and
if the bandwidth estimation is less than the padding threshold, determining the padding budget by subtracting a bitrate of the received, highest quality data stream from the bandwidth estimation.

5. The method of claim 1, wherein the padding threshold is determined using a probing technique.

6. The method of claim 1, wherein the padding baseline is determined using a probing technique.

7. The method of claim 1, further comprising;
receiving Real-Time Transport Protocol (RTP) feedback data from the intended subscriber; and
determining the bandwidth estimation using the RTP feedback data.

8. An apparatus for determining a padding budget for improving bandwidth estimation of data streams encoded with variable bitrate, comprising:
a receiver bandwidth estimator configure to:
receive a data stream having a variable bitrate; and
determine a bandwidth estimation of a communication path between the apparatus and a respective, intended receiver of the data stream; and
a padding adder configure to:
compare a bandwidth estimation determined for a communication path between a data stream forwarding unit and an intended receiver of the data stream to a padding threshold;
if the bandwidth estimation is less than the padding threshold, determine the padding budget by subtracting a bitrate of the received data stream from the bandwidth estimation;
if the bandwidth estimation is not less than the padding threshold, compare the bitrate of the received data stream to a padding baseline;
if the bitrate of the received data stream is less than the padding baseline, determine the padding budget by subtracting the bitrate of the received data stream from the padding baseline; and
if the bitrate of the received data stream is not less than the padding baseline, determine that the padding budget is zero and that no padding needs to be added to the data stream to be communicated to the intended receiver.

9. The apparatus of claim 8, wherein the padding adder is further configured to:
add padding to the data stream in accordance with the determined padding budget.

10. The apparatus of claim 9, further comprising:
a sending engine configured to communicate the data stream including the added padding to the respective, intended receiver.

11. The apparatus of claim 8, wherein the received data stream comprises a multi-quality data stream and the padding adder is further configured to:
compare a bandwidth estimation determined for a communication path between the data stream forwarding unit and an intended receiver of the data stream having a highest quality of the multi-quality data stream; and
if the bandwidth estimation is less than the padding threshold, determine the padding budget by subtracting a bitrate of the received, highest quality data stream from the bandwidth estimation.

12. The apparatus of claim 8, wherein the padding threshold is determined using a probing technique.

13. The apparatus of claim 8, wherein the padding baseline is determined using a probing technique.

14. The apparatus of claim 8, wherein the receiver bandwidth estimator is further configured to:
receive Real-Time Transport Protocol (RTP) feedback data from the respective, intended subscriber; and
determine the bandwidth estimation using the RTP feedback data.

15. An apparatus for determining a padding budget for improving bandwidth estimation of data streams encoded with variable bitrate, comprising:
a processor; and
a memory coupled to the processor, the memory having stored therein at least one of programs or instructions executable by the processor to configure the apparatus to:
receive a data stream having a variable bitrate;
compare a bandwidth estimation determined for a communication path between a data stream forwarding unit and a respective, intended receiver of the data stream to a padding threshold;
if the bandwidth estimation is less than the padding threshold, determine the padding budget by subtracting a bitrate of the received data stream from the bandwidth estimation;
if the bandwidth estimation is not less than the padding threshold, compare the bitrate of the received data stream to a padding baseline;
if the bitrate of the received data stream is less than the padding baseline, determine the padding budget by subtracting the bitrate of the received data stream from the padding baseline; and
if the bitrate of the received data stream is not less than the padding baseline, determine that the padding budget is zero and that no padding needs to be added to the data stream to be communicated to the intended receiver.

16. The apparatus of claim 15, wherein the apparatus is further configured to:
add padding to the data stream in accordance with the determined padding budget.

17. The apparatus of claim 16, wherein the apparatus is further configured to:
communicate the data stream including the added padding to the respective, intended receiver.

18. The apparatus of claim 15, wherein the received data stream comprises a multi-quality data stream and the apparatus is further configured to:
compare a bandwidth estimation determined for a communication path between the data stream forwarding unit and an intended receiver of the data stream having a highest quality of the multi-quality data stream; and
if the bandwidth estimation is less than the padding threshold, determine the padding budget by subtracting a bitrate of the received, highest quality data stream from the bandwidth estimation.

19. The apparatus of claim 15, wherein the padding threshold is determined using a probing technique.

20. The apparatus of claim 15, wherein the padding baseline is determined using a probing technique.

21. The apparatus of claim 15, wherein the apparatus is further configured to:
receive Real-Time Transport Protocol (RTP) feedback data from the respective, intended subscriber; and
determine the bandwidth estimation using the RTP feedback data.
